(19) United States
(12) Patent Application Publication
(10) Pub. No.: US 2026/0213416 A1
(43) Pub. Date: Jul. 23, 2026

(54) ELECTRONIC APPARATUS AND METHOD FOR ADAPTIVELY ADJUSTING ANTENNA POWER

(71) Applicant: ASUSTeK COMPUTER INC., Taipei (TW)

(72) Inventors: Wei-Cheng Lo, Taipei (TW); Kuo-Chu Liao, Taipei (TW); Chun-Chieh Su, Taipei (TW); Kuan-Yu Chen, Taipei (TW)

(21) Appl. No.: 19/449,841

(22) Filed: Jan. 15, 2026

(30) Foreign Application Priority Data
Jan. 17, 2025 (TW) 114102177

(51) Int. Cl. H01Q 9/04; H01Q 5/335

(52) U.S. Cl. CPC H01Q 9/0442; H01Q 5/335

(57) ABSTRACT

The disclosure provides an electronic device for adaptively adjusting antenna power and a method thereof. In the electronic device, a plurality of groups of tuners is electrically connected to antennas respectively, so that each group of tuners corresponds to an antenna. The modem is electrically connected to the tuners to control the tuners and obtain status information of each of the tuners. A processing device is electrically connected to the modem and determines the operation of the tuners according to changes of the status information. When only one group of the tuners acts or adjacent groups act simultaneously, the processing device sets an output power of the modem to a limb specific absorption rate mode. When all groups of the tuners act or relatively long side groups act at the same time, the processing device sets the output power of the modem to a body specific absorption rate mode.

### CROSS-REFERENCE TO RELATED APPLICATION

This application claims the priority benefit of Taiwan application serial No. 114102177, filed on Jan. 17, 2025. The entirety of the above-mentioned patent application is hereby incorporated by reference herein and made a part of the specification.

### BACKGROUND OF THE INVENTION

### Field of the Invention

The disclosure relates to an electronic apparatus and a method for adaptively adjusting transmit power of an antenna based on a usage scenario.

### Description of the Related Art

Currently, before an electronic product including an electronic apparatus (including a 2G/3G/4G/5G mobile communication system, a wireless personal area network WPAN, or the like) that supports adaptively adjusting antenna power is sold in each country, the electronic product needs to be authenticated by a mandatory regulation of each country. A security specification includes a test of a human body specific absorption rate (Specific Absorption Rate, SAR). The human body specific absorption rate is generally tested in the following several scenarios: a head specific absorption rate (Head SAR), a whole-body specific absorption rate (Body SAR), an extremity specific absorption rate (Extremity SAR or Limb SAR), and a simultaneous transmit specific absorption rate (co-SAR or Hot Spot SAR). This test affects transmit power. If neither a sensor nor another mechanism is used for distinguishing, a free space scenario where original transmit power need not be reduced will be directly impacted, thereby affecting user experience. The tests in the two scenarios of the whole-body specific absorption rate and the extremity specific absorption rate need to be distinguished by using an additional component (in an embodiment, a capacitive coupling sensor) or another mechanism. However, using additional components increases costs, consumes power, and even affects antenna performance. Further, using another mechanism lacks accuracy and needs to limit a use occasion, causing a delayed response.

### BRIEF SUMMARY OF THE INVENTION

The disclosure provides an electronic apparatus for adaptively adjusting antenna power. The electronic apparatus includes a plurality of antennas, a plurality of tuner groups, a modem, and a processing apparatus. The plurality of tuner groups is electrically connected to the antennas, to enable each of the tuner groups to correspond to one of the antennas. The modem is electrically connected to the plurality of tuner groups to control the tuners and obtain respective status information of the plurality of tuner groups. The processing apparatus is electrically connected to the modem. The processing apparatus determines actuation of the plurality of tuner groups based on changes of the status information. The processing apparatus sets output power of the modem to an extremity specific absorption rate mode when only one tuner group is actuated or adjacent tuner groups are actuated simultaneously in the plurality of tuner groups. Alternatively, the processing apparatus sets the output power of the modem to a whole-body specific absorption rate mode when all the tuner groups are actuated or opposing long-side tuner groups are actuated simultaneously in the plurality of tuner groups.

The disclosure further provides a method for adaptively adjusting antenna power. The method is applied to an electronic apparatus. The electronic apparatus includes a plurality of antennas, a plurality of tuner groups, and a modem. The method includes steps of: obtaining respective status information of the plurality of tuner groups; determining actuation of the plurality of tuner groups based on changes of the status information, and determining a quantity of tuner groups that change in the plurality of tuner groups when the status information changes; and setting output power of the modem to an extremity specific absorption rate mode when only one tuner group is actuated or adjacent tuner groups are actuated simultaneously in the plurality of tuner groups; setting the output power of the modem to a whole-body specific absorption rate mode when all the tuner groups are actuated or opposing long-side tuner groups are actuated simultaneously in the plurality of tuner groups.

In conclusion, the disclosure provides the electronic apparatus and the method for adaptively adjusting the antenna power. A current usage scenario of the electronic apparatus is determined by directly detecting, in real time, a change of a component configured to enhance antenna performance, such as an antenna tuner, so as to adjust the output power. Therefore, in the disclosure, accuracy and timeliness of determining a specific absorption rate mode are enhanced, and there is no power consumption of an additional component in a determining process.

### BRIEF DESCRIPTION OF THE DRAWINGS

FIG. 1 is a schematic block diagram of an electronic apparatus for adaptively adjusting antenna power according to an embodiment of the disclosure;

FIG. 2 is a schematic diagram of an electronic apparatus provided with an antenna according to an embodiment of the disclosure;

FIG. 3 is a schematic flowchart of performing a complete method for determining a specific absorption rate mode by an electronic apparatus according to an embodiment of the disclosure;

FIG. 4 is a schematic flowchart of a method for adaptively adjusting antenna power according to an embodiment of the disclosure; and

FIG. 5 is a schematic flowchart of a method for adaptively adjusting antenna power according to another embodiment of the disclosure.

### DETAILED DESCRIPTION OF THE EMBODIMENTS

The following describes embodiments of the disclosure with reference to related drawings. In addition, some components or structures are omitted in the drawings of the disclosure, to clearly show technical features of the disclosure. In the drawings, same numbers represent same or similar components or circuits. It is to be understood that, although terms “first”, “second”, and the like are used to describe various components, parts, regions, or functions in this specification, these components, parts, regions, and/or functions should not be limited by these terms, and these terms are merely used to separate one component, part, region, or function from another component, part, region, or functional region.

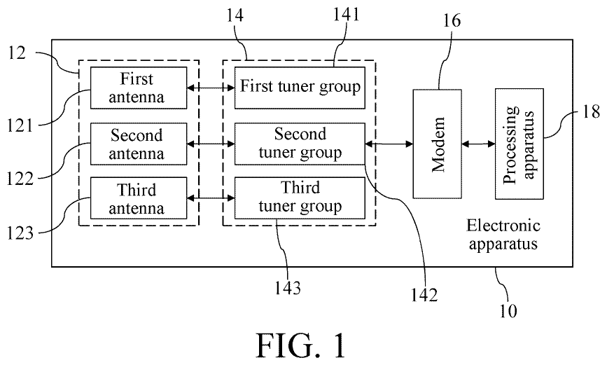

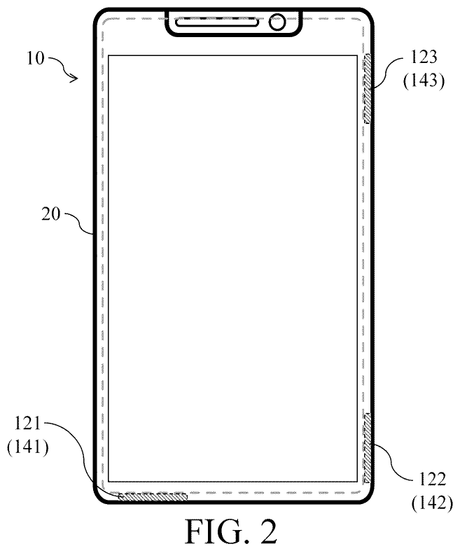

With reference to FIG. 1 and FIG. 2, an electronic apparatus 10 for adaptively adjusting antenna power includes a plurality of antennas 12, a plurality of tuner groups 14, a modem 16, and a processing apparatus 18. In an embodiment, the electronic apparatus 10 is a mobile phone herein. In the electronic apparatus 10, the plurality of antennas 12 is respectively uniformly disposed on a housing 20. The housing 20 includes a border frame and a back cover, and a configuration of the plurality of antennas 12 includes a plurality of options. In an embodiment, there are three antennas 12 herein, including a first antenna 121, a second antenna 122, and a third antenna 123. The first antenna 121, the second antenna 122, and the third antenna 123 are disposed at any suitable position in the housing 20. In this embodiment, the first antenna 121 is disposed at a position below the housing 20, the second antenna 122 is disposed at a position below a long side of the housing 20, and the third antenna 123 is disposed at a position above the long side of the housing 20. However, the disclosure is not limited thereto.

The plurality of tuner groups 14 is respectively electrically connected to the antennas 12, to enable each of the tuner groups 14 to correspond to one of the antennas 12. Because each of the antennas 12 corresponds to a plurality of tuners 14, the tuners 14 corresponding to each of the antennas 12 are considered as one group. To be specific, a first tuner group 141 is electrically connected to the first antenna 121, a second tuner group 142 is electrically connected to the second antenna 122, and a third tuner group 143 is electrically connected to the third antenna 123. The modem 16 is electrically connected to the first tuner group 141, the second tuner group 142, and the third tuner group 143. The modem 16 generates a first control signal to separately control the first tuner group 141, the second tuner group 142, and the third tuner group 143. The modem 16 also obtains respective status information of the first tuner group 141, the second tuner group 142, and the third tuner group 143 when controlling the first tuner group 141, the second tuner group 142, and the third tuner group 143, and feeds back the status information to the processing apparatus 18 in real time. In an embodiment, the status information is configuration changes of the first tuner group 141, the second tuner group 142, and the third tuner group 143.

The processing apparatus 18 is electrically connected to the modem 16. The processing apparatus 18 determines actuation of the first tuner group 141, the second tuner group 142, and the third tuner group 143 based on changes of the status information. The processing apparatus 18 generates a second control signal to the modem 16 when only one of the first tuner group 141, the second tuner group 142, and the third tuner group 143 is actuated or adjacent tuner groups are actuated simultaneously in the first tuner group 141, the second tuner group 142, and the third tuner group 143, to set output power of the modem 16 to an extremity specific absorption rate (Extremity SAR or Limb SAR) mode based on the second control signal. The processing apparatus 18 generates the second control signal to the modem 16 when all the tuner groups are actuated or opposing long-side tuner groups are actuated simultaneously in the first tuner group 141, the second tuner group 142, and the third tuner group 143, to set the output power of the modem 16 to a whole-body specific absorption rate (Body SAR) mode based on the second control signal. Therefore, the processing apparatus 18 adaptively adjusts the output power into the extremity specific absorption rate mode or the whole-body specific absorption rate mode based on the changes of the status information.

In an embodiment, in addition to the mobile phone described above, the electronic apparatus 10 is alternatively a personal digital assistant, a tablet computer, or the like. However, the disclosure is not limited thereto. Any portable electronic apparatus having a mobile communication function is included in the disclosure.

In an embodiment, the first tuner group 141 is an antenna impedance tuner, an antenna aperture tuner, a phase tuner, or any combination thereof. The second tuner group 142 is an antenna impedance tuner, an antenna aperture tuner, a phase tuner, or any combination thereof. The third tuner group 143 is an antenna impedance tuner, an antenna aperture tuner, a phase tuner, or any combination thereof.

In an embodiment, the processing apparatus 18 is a central processing unit (central processing unit, CPU), or a general-purpose or dedicated microprocessor (microprocessor), a microcontroller (microcontroller), a micro control unit (micro control unit, MCU), a digital signal processor (digital signal processor, DSP), a programmable controller, an application-specific integrated circuit (application-specific integrated circuit, ASIC), or another similar component or combination of the foregoing components used. This is not limited in the disclosure.

In an embodiment, the first control signal is a general-purpose input/output (General-purpose input/output, GPIO) signal or a mobile industry processor Interface (Mobile Industry Processor Interface, MIPI) signal, or another similar control signal. This is not limited in the disclosure. The second control signal is a peripheral component interconnect express apparatus (PCIe) Signal, an in-phase and quadrature signal (IQ Signal), or another similar apparatus connection and communication signal. This is not limited in the disclosure. Based on this, the modem 16 controls operation of the first tuner group 141, the second tuner group 142, and the third tuner group 143 by using the general-purpose input/output signal, the mobile industry processor Interface signal, or another similar control signal, and the processing apparatus 18 controls operation of the modem 16 by using the peripheral component interconnect express apparatus signal, the in-phase and quadrature signal, or another similar apparatus connection and communication signal.

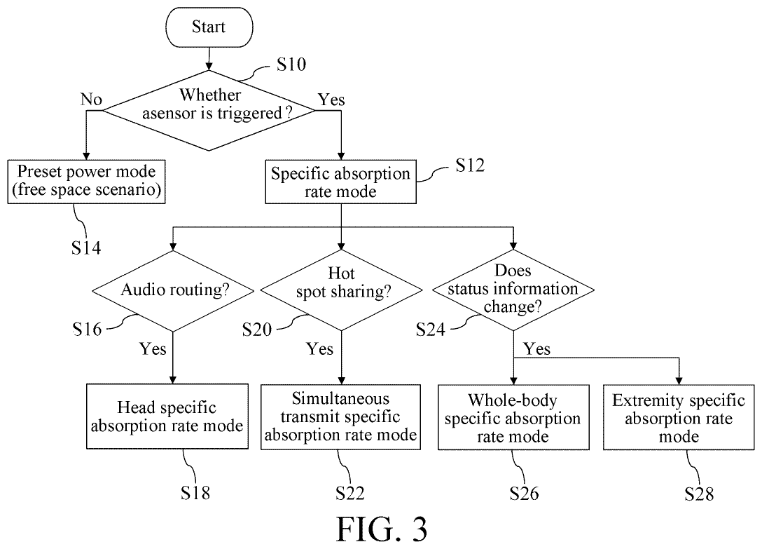

With reference to FIG. 1, FIG. 2, and FIG. 3, when the electronic apparatus 10 performs a complete procedure of determining a specific absorption rate mode, the process includes the following steps. As shown in step S10, the processing apparatus 18 determines whether a sensor (not shown in the figure) is triggered. If the sensor is triggered, as shown in step S12, a procedure of determining the specific absorption rate mode is entered. If the sensor is not triggered, as shown in step S14, a free space (Free space) scenario is entered to maintain the output power of the modem 16 in a default power mode without reducing the output power. The default power mode includes a maximum power value (to be specific, a maximum power value of the electronic apparatus), and the maximum power value is usually a statutory value stipulated by an SAR regulation. After the procedure of determining the specific absorption rate mode shown in step S12 is entered, state determining of step S16, step S20, and step S24 is performed simultaneously. As shown in step S16, the processing apparatus 18 determines whether there is audio routing (Audio Routing). If there is the audio routing, as shown in step S18, the processing apparatus 18 determines that a head specific absorption rate (Head SAR) mode needs to be used for the output power, and sets the output power of the modem 16 to the head specific absorption rate mode. As shown in step S20, the processing apparatus 18 determines whether there is hot spot sharing. If there is the hot spot sharing, as shown in step S22, the processing apparatus 18 determines that a simultaneous transmit specific absorption rate (co-SAR or Hot Spot SAR) mode needs to be used for the output power, and sets the output power of the modem 16 to the simultaneous transmit specific absorption rate mode. As shown in step S24, the processing apparatus 18 determines whether the status information of the first tuner group 141, the second tuner group 142, and the third tuner group 143 changes. If the status information changes, as shown in step S26 and step S28, the processing apparatus 18 determines that the whole-body specific absorption rate (Body SAR) mode or the extremity specific absorption rate (Extremity SAR or Limb SAR) mode needs to be used for the output power. A detailed procedure of distinguishing the whole-body specific absorption rate mode or the extremity specific absorption rate mode based on the change of the status information is described below.

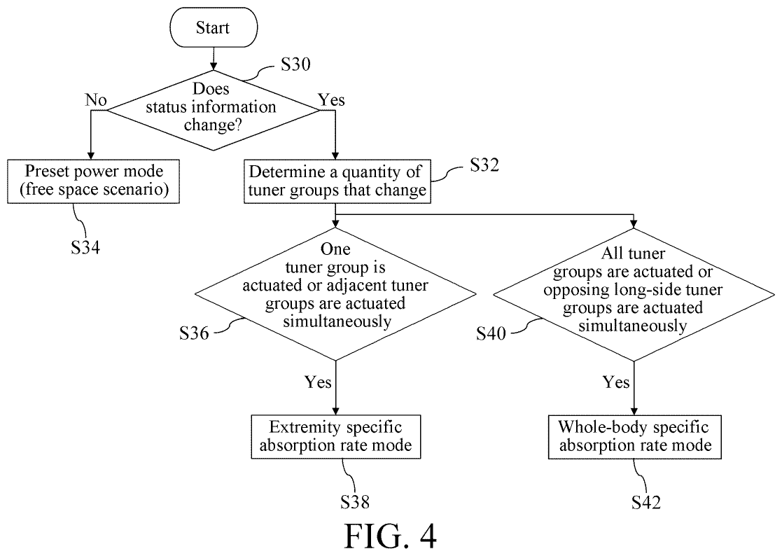

With reference to FIG. 1, FIG. 2, and FIG. 4, a procedure of performing, by the electronic apparatus 10, the method for adaptively adjusting the antenna power includes the following steps. As shown in step S30, the processing apparatus 18 determines the actuation of the first group the first tuner group 141, the second tuner group 142, and the third tuner group 143 based on the change of the status information, to determine whether the first tuner group 141, the second tuner group 142, and the third tuner group 143 change. If the status information changes, a next step S32 continues to be performed. If no change occurs, as shown in step S34, the free space (Free space) scenario is entered to maintain the output power of the modem 16 in the default power mode without reducing the output power. As shown in step S32, the processing apparatus 18 determines a quantity of tuner groups that change in the first tuner group 141, the second tuner group 142, and the third tuner group 143, to perform subsequent step S36 and step S40. As shown in step S36, the processing apparatus 18 determines whether only one tuner group is actuated or adjacent tuner groups are actuated simultaneously in the first tuner group 141, the second tuner group 142, and the third tuner group 143. If only one tuner group is actuated or adjacent tuner groups are actuated simultaneously, in an embodiment, the first tuner group 141, the second tuner group 142, or the third tuner group 143 is actuated individually, or adjacent tuner groups in the first tuner group 141, the second tuner group 142, and the third tuner group 143 are actuated simultaneously, as shown in step S38, the processing apparatus 18 sets the output power of the modem 16 to the extremity specific absorption rate mode. Alternatively, as shown in step S40, the processing apparatus 18 determines whether all the tuner groups are actuated or opposing long-side tuner groups are actuated simultaneously in the first tuner group 141, the second tuner group 142, and the third tuner group 143. If all the tuner groups are actuated or the opposing long-side tuner groups are actuated simultaneously, in an embodiment, the first tuner group 141, the second tuner group 142, and the third tuner group 143 are all actuated simultaneously, or opposing long-side tuner groups of the first tuner group 141 and the third tuner group 143 or opposing long-side tuner groups of the second tuner group 142 and the third tuner group 143 are actuated simultaneously, as shown in step S42, the processing apparatus 18 sets the output power of the modem 16 to the whole-body specific absorption rate mode.

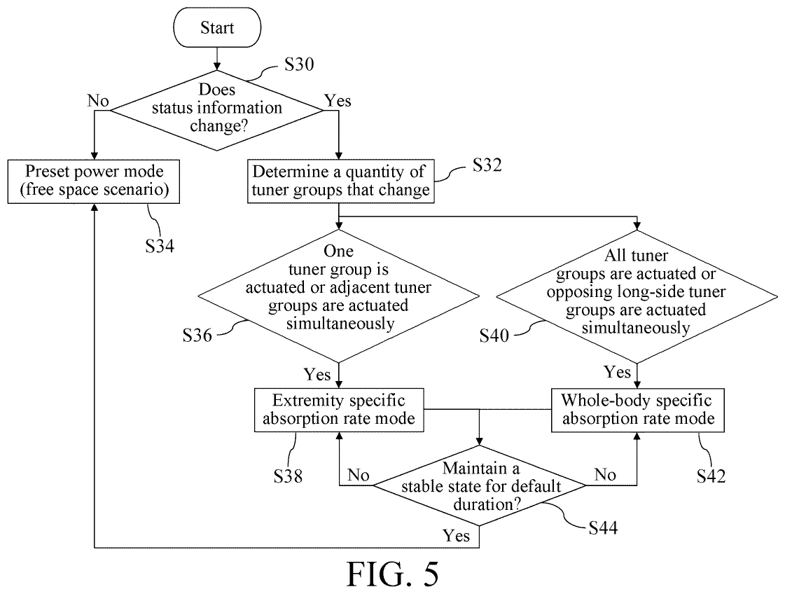

In addition, an object of a metal material, such as a desk, affects antenna performance, and as a result, the tuners 14 of the antenna 12 change. However, in this case, the power does not need to be reduced, but it is incorrectly determined that a human body approaches. In addition, a scenario in which a human body approaches is usually unstable, that is, slight shaking occurs. Therefore, the disclosure adds a detection threshold by using this feature. In an embodiment, whether to change the specific absorption rate mode is determined by detecting whether a changing range of the tuners 14 is fixed to a specific value within a period of time. With reference to FIG. 1, FIG. 2, and FIG. 5, as shown in step S38 and step S42, after the processing apparatus 18 sets the output power of the modem 16 to the extremity specific absorption rate mode or the whole-body specific absorption rate mode, as shown in step S44, the processing apparatus 18 further determines whether the status information maintains a stable state for default duration. If the status information maintains the stable state for the default duration, as shown in step S34, it indicates that the electronic apparatus 10 needs to be in a placement scenario (not on a human body), the free space scenario is entered, and the processing apparatus 18 restores a setting of the output power of the modem 16 to the default power mode. If the status information does not maintain the stable state for the default duration, the output power of the modem 16 continues to maintain the original extremity specific absorption rate mode or whole-body specific absorption rate mode, to maintain optimal communication power. In an embodiment, the default duration is 30 seconds. The remaining steps are the same as those in the embodiment of FIG. 4. For details, refer to the foregoing descriptions, and details are not described herein again.

When quantities of antennas and groups of antenna tuners increase in the future, placement of an electronic apparatus (a mobile communication product), in an embodiment, the electronic apparatus is placed on a desktop with a screen facing upward or facing downwards, is determined by using a changed parameter value of status information calibrated in advance. In this case, a radiation pattern on a covered side of the antenna is shaded. Therefore, in this case, a direction of the radiation pattern of the antenna is changed by using the antenna tuner, and the radiation pattern is rotated and concentrated on an unshaded surface as much as possible, to enhance current antenna efficiency. Therefore, a larger quantity and more uniform distribution of the groups of antenna tuner bring a possibility of determining more usage scenarios, to adjust an antenna phase in a specific environment, so that a radiation direction is more concentrated in an unshaded direction, so as to enhance overall performance of the antenna.

In conclusion, the disclosure provides the electronic apparatus and the method for adaptively adjusting the antenna power. A current usage scenario of the electronic apparatus is determined by directly detecting, in real time, a change of a component configured to enhance antenna performance, such as an antenna tuner, so as to adjust the output power. Therefore, the antenna has better communication quality in a specific scenario, and also meet requirements of SAR regulations. Therefore, in the disclosure, accuracy and timeliness of determining the specific absorption rate mode are enhanced, and there is no power consumption of an additional component in a determining process. In addition, in the disclosure, after a usage scenario is determined, the antenna phase is further adjusted by using the antenna tuner, so that the radiation pattern of the antenna is more concentrated on a target terminal, thereby effectively enhancing antenna effectiveness.

The foregoing described embodiments are merely intended to describe the technical ideas and features of the disclosure, and the objective thereof is to enable a person skilled in the art to understand the content of the disclosure and implement the disclosure. The patent scope of the disclosure is not limited thereto, that is, equivalent changes or modifications made to a large deal according to the spirit disclosed in the disclosure shall fall within the patent scope of the disclosure.

What is claimed is:

1. An electronic apparatus for adaptively adjusting antenna power, wherein the electronic apparatus comprises:
a plurality of antennas;
a plurality of tuner groups, electrically connected to the antennas respectively, to enable each of the tuner groups to correspond to one of the antennas;
a modem, electrically connected to the plurality of tuner groups, to control the plurality of tuner groups and obtain respective status information of the plurality of tuner groups; and
a processing apparatus, electrically connected to the modem, wherein the processing apparatus determines actuation of the plurality of tuner groups based on changes of the status information; and the processing apparatus sets output power of the modem to an extremity specific absorption rate mode when only one tuner group is actuated or adjacent tuner groups are actuated simultaneously in the plurality of tuner groups; the processing apparatus sets the output power of the modem to a whole-body specific absorption rate mode when all the tuner groups are actuated or opposing long-side tuner groups are actuated simultaneously in the plurality of tuner groups.

2. The electronic apparatus for adaptively adjusting the antenna power according to claim 1, wherein the tuner is an antenna impedance tuner, an antenna aperture tuner, a phase tuner, or any combination thereof.

3. The electronic apparatus for adaptively adjusting the antenna power according to claim 1, wherein the status information is configuration changes of the plurality of tuner groups.

4. The electronic apparatus for adaptively adjusting the antenna power according to claim 1, wherein the modem generates a first control signal to control the plurality of tuner groups.

5. The electronic apparatus for adaptively adjusting the antenna power according to claim 4, wherein the first control signal is a general-purpose input/output signal or a mobile industry processor interface signal.

6. The electronic apparatus for adaptively adjusting the antenna power according to claim 1, wherein the processing apparatus generates a second control signal to the modem when only one tuner group is actuated or the adjacent tuner groups are actuated simultaneously in the plurality of tuner groups, to set the output power of the modem to the extremity specific absorption rate mode based on the second control signal; or the processing apparatus generates the second control signal to the modem when all the tuner groups are actuated or the opposing long-side tuner groups are actuated simultaneously in the plurality of tuner groups, to set the output power of the modem to the whole-body specific absorption rate mode based on the second control signal.

7. The electronic apparatus for adaptively adjusting the antenna power according to claim 6, wherein the second control signal is a peripheral component interconnect express apparatus signal or an in-phase and quadrature signal.

8. The electronic apparatus for adaptively adjusting antenna power according to claim 1, wherein the plurality of antennas is respectively uniformly disposed on a housing of the electronic apparatus.

9. The electronic apparatus for adaptively adjusting the antenna power according to claim 1, wherein after the processing apparatus sets the output power of the modem to the extremity specific absorption rate mode or whole-body specific absorption rate mode, the processing apparatus further determines whether the status information maintains a stable state for default duration, and if the status information maintains the stable state for the default duration, the processing apparatus restores a setting of the output power of the modem to a default power mode; or if the status information does not maintain the stable state for the default duration, the processing apparatus maintains the extremity specific absorption rate mode or the whole-body specific absorption rate mode.

10. The electronic apparatus for adaptively adjusting the antenna power according to claim 9, wherein the default power mode comprises a maximum power value.

11. A method for adaptively adjusting antenna power, wherein the method is applied to an electronic apparatus, the electronic apparatus comprises a plurality of antennas, a plurality of tuner groups, and a modem, and the method comprises:
obtaining respective status information of the plurality of tuner groups;
determining actuation of the plurality of tuner groups based on changes of the status information, and determining a quantity of tuner groups that change in the plurality of tuner groups when the status information changes; and
setting output power of the modem to an extremity specific absorption rate mode when only one tuner group is actuated or adjacent tuner groups are actuated simultaneously in the plurality of tuner groups; or
setting the output power of the modem to a whole-body specific absorption rate mode when all the tuner groups are actuated or opposing long-side tuner groups are actuated simultaneously in the plurality of tuner groups.

12. The method for adaptively adjusting the antenna power according to claim 11, wherein the tuner is an antenna impedance tuner, an antenna aperture tuner, a phase tuner, or any combination thereof.

13. The method for adaptively adjusting the antenna power according to claim 11, wherein the status information is configuration changes of the plurality of tuner groups.

14. The method for adaptively adjusting the antenna power according to claim 11, wherein the modem is controlled by using a second control signal when only one tuner group is actuated or the adjacent tuner groups are actuated simultaneously in the plurality of tuner groups, to set the output power of the modem to the extremity specific absorption rate mode based on the second control signal; and the modem is controlled by using the second control signal when all the tuner groups are actuated or the opposing long-side tuner groups are actuated simultaneously in the plurality of tuner groups, to set the output power of the modem to the whole-body specific absorption rate mode based on the second control signal.

15. The method for adaptively adjusting the antenna power according to claim 14, wherein the second control signal is a peripheral component interconnect express apparatus signal or an in-phase and quadrature signal.

16. The method for adaptively adjusting the antenna power according to claim 11, wherein the plurality of antennas is respectively uniformly disposed on a housing of the electronic apparatus.

17. The method for adaptively adjusting the antenna power according to claim 11, wherein after the output power of the modem is set to the extremity specific absorption rate mode or the whole-body specific absorption rate mode, whether the status information maintains a stable state for default duration is further determined, and if the status information maintains the stable state for the default duration, the setting of the output power of the modem is restored to a default power mode; or if the status information does not maintain the stable state for the default duration, the extremity specific absorption rate mode or the whole-body specific absorption rate mode is maintained.

18. The method for adaptively adjusting the antenna power according to claim 17, wherein the default power mode comprises a maximum power value.
